(19) United States
(12) Patent Application Publication
(10) Pub. No.: US 2014/0099555 A1
(43) Pub. Date: Apr. 10, 2014

(54) NONAQUEOUS ELECTROLYTIC SOLUTION SECONDARY BATTERY AND METHOD OF MANUFACTURING THE BATTERY

(71) Applicants: Hiroshi ONIZUKA, Toyota-shi (JP); Tomohiro NAKANO, Okazaki-shi (JP); Kyoko KIKUCHI, Seto-shi (JP)

(72) Inventors: Hiroshi ONIZUKA, Toyota-shi (JP); Tomohiro NAKANO, Okazaki-shi (JP); Kyoko KIKUCHI, Seto-shi (JP)

(73) Assignee: TOYOTA JIDOSHA KABUSHIKI KAISHA, Toyota-shi (JP)

(21) Appl. No.: 14/036,623

(22) Filed: Sep. 25, 2013

(30) Foreign Application Priority Data
Oct. 9, 2012 (JP) 2012-224607

(51) Int. Cl. H01M 4/36; H01M 4/04

(52) U.S. Cl. CPC H01M 4/366; H01M 4/0402
USPC 429/231.8; 429/218.1; 29/623.5

(57) ABSTRACT

A nonaqueous electrolytic solution secondary battery includes: a positive electrode; a negative electrode provided with a negative electrode active material layer containing at least a negative electrode active material; a nonaqueous electrolytic solution; and a coat containing phosphorus (P) atoms formed on a surface of the negative electrode active material, in which a ratio of an amount of phosphorus atoms per unit area of the negative electrode active material layer Mₚ with respect to a capacitance per unit area of the negative electrode active material layer C_{dl} (Mₚ/C_{dl} ratio) is 0.79 μmol/mF≦Mₚ/C_{dl}≦1.21 μmol/mF.

### INCORPORATION BY REFERENCE

The disclosure of Japanese Patent Application No. 2012-224607 filed on Oct. 9, 2012 including the specification, drawings and abstract is incorporated herein by reference in its entirety.

### BACKGROUND OF THE INVENTION

1. Field of the Invention

The invention relates to a nonaqueous electrolytic solution secondary battery. In more detail, the invention relates to a nonaqueous electrolytic solution secondary battery provided with a coat containing phosphorus (P) atoms in a negative electrode.

2. Description of Related Art

Nonaqueous electrolytic solution-secondary batteries including a lithium ion secondary battery and other batteries have a smaller size, a lighter weight, and a higher energy density than other general batteries, and are excellent also in output density. Therefore, these batteries are preferably used as a so-called portable power source for personal computers, portable terminals, and the like, and a battery mounted on vehicle (vehicle driving power source, for example).

In the nonaqueous electrolytic solution secondary battery, during charge, a nonaqueous electrolytic solution is partially decomposed. On a surface of a negative electrode active material, an SEI (Solid Electrolyte Interface) coat made of decomposed products thereof is formed. Owing to the coat, a nonaqueous electrolytic solution can be hindered from decomposing accompanying the following charge/discharge, and the endurance of the battery can be improved. Further, in order to make such a coat more excellent, a method where an additive agent that can be decomposed at a potential lower than those of constituent components (typically nonaqueous solvent) of the nonaqueous electrolytic solution and can form a coat on a surface of the negative electrode active material (hereinafter, referred to as “coat forming agent”) is added in advance in the nonaqueous electrolytic solution is known. For example, in Japanese Patent Application Publication No. 2004-031079 (JP 2004-031079 A), a nonaqueous electrolytic solution secondary battery that contains difluorophosphate as the coat forming agent in a nonaqueous electrolytic solution is disclosed.

In the battery like this, during charge, firstly, the coat forming agent (difluorophosphate, for example) having a lower decomposition potential is decomposed. After that, a high quality coat having excellent stability is formed on a surface of the negative electrode active material. The nonaqueous electrolytic solution can be properly hindered by such a coat from decomposing accompanying charge/discharge after that. Therefore, the endurance (high temperature storage characteristics and charge/discharge cycle characteristics, for example) of the battery can be improved. On the other hand, resistance accompanying a charge/discharge reaction (storage and release of charge carriers) increases owing to the coat like this, and other battery characteristics (input/output characteristics, for example) may be degraded.

An amount of the coat forming agent added in the battery has been usually determined in accordance with a liquid amount of the nonaqueous electrolytic solution and physical properties (specific surface area and pore volume, for example) of the negative electrode active material. However, according to study of the inventors, a decision method of an addition amount like this has difficulty in adequately dealing with a variation of other design parameters (basis weight and density of a negative electrode active material layer, for example). That is, a coat amount on a surface of the negative electrode active material is occasionally insufficient to induce degradation of the endurance, and a coat amount is occasionally excessive to induce an increase in the resistance.

### SUMMARY OF THE INVENTION

The invention provides a nonaqueous electrolytic solution secondary battery that can appropriately exert a coat forming agent addition effect and can exert a higher battery performance (capable of combining the endurance and input/output characteristics at a high level, for example).

A first aspect of the invention relates to a nonaqueous electrolytic solution secondary battery. The nonaqueous electrolytic solution secondary battery includes a positive electrode, a negative electrode provided with a negative electrode active material layer containing at least a negative electrode active material, a nonaqueous electrolytic solution, and a coat containing phosphorus (P) atoms formed on a surface of the negative electrode active material. A ratio of an amount of phosphorus atoms per unit area of the negative electrode active material layer Mₚ with respect to a capacitance per unit area of the negative electrode active material layer C_{dl} (Mₚ/C_{dl} ratio) is 0.79 μmol/mF≦Mₚ/C_{dl}≦1.2 μmol/mF.

A second aspect of the invention relates to a method of manufacturing a nonaqueous electrolytic solution secondary battery that includes an electrode body provided with a positive electrode having a positive electrode active material and a negative electrode having a negative electrode active material, a battery case, and a nonaqueous electrolytic solution in which a fluorine-containing phosphate compound as a phosphorus-containing coat forming agent is added. The manufacturing method like this includes the following steps of (1) housing the electrode body in the battery case, (2) injecting the nonaqueous electrolytic solution in the battery case, (3) performing a charging between the positive electrode and the negative electrode to form a coat containing phosphorus (P) atoms derived from the fluorine-containing phosphate compound on a surface of the negative electrode active material, and (4) determining an addition amount of the fluorine-containing phosphate compound so that a ratio of an amount of phosphorus atoms per unit area of the negative electrode active material layer Mₚ with respect to a capacitance per unit area of the negative electrode active material layer C_{dl} (Mₚ/C_{dl} ratio) is within the range of 0.79 μmol/mF≦Mₚ/C_{dl}≦1.21 μmol/mF.

According to the first and second aspects, the nonaqueous electrolytic solution secondary battery can be rendered low in the internal resistance and excellent in the endurance. For example, a nonaqueous electrolytic solution secondary battery that is excellent in the input/output characteristics and less in capacity degradation even after repetition of the charge/discharge under high temperature environment can be obtained. Accordingly, by making use of such the features, the nonaqueous electrolytic solution secondary batteries can be preferably used as power sources (driving power sources) for hybrid vehicles and electric vehicles, for example.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view schematically showing an exterior shape of a nonaqueous electrolytic solution secondary battery according to one embodiment of the invention;

FIG. 2 is a II-II line cross sectional view of the nonaqueous electrolytic solution secondary battery of FIG. 1;

FIG. 3 is a schematic diagram showing a structure of a wound electrode body of the nonaqueous electrolytic solution secondary battery according to one embodiment of the invention;

FIG. 4 is a graph showing a relationship between an addition amount of lithium difluorophosphate and an amount of phosphorus atoms Mₚ;

FIG. 5 is a graph showing a relationship between an Mₚ/C_{dl} ratio and a reaction resistance; and

FIG. 6 is a graph showing a relationship between an Mₚ/C_{dl} ratio and an amount of heat generation.

### DETAILED DESCRIPTION OF EMBODIMENTS

Hereinafter, embodiments of the invention will be described. Items that are not particularly referred to in the specification but are necessary for carrying out the invention (for example, methods of manufacturing a positive electrode active material and a negative electrode active material, general technologies relating to construction of a battery) can be grasped as design matters of skilled persons based on relating technologies in the field. The invention can be carried out based on the content disclosed in the present specification and technical common sense in the field. As one embodiment of a nonaqueous electrolytic solution secondary battery, in some cases, a lithium ion secondary battery is described as an example. However, it is not intended to limit an application target of the invention to such embodiments.

A nonaqueous electrolytic solution secondary battery disclosed herein includes a positive electrode, a negative electrode, and a nonaqueous electrolytic solution, and these are housed in a predetermined battery case. The negative electrode includes a negative electrode active material layer containing at least a negative electrode active material. And, a coat containing phosphorus (P) atoms (substantially, a coat derived from a fluorine-containing phosphate compound, for example, a coat derived from difluorophosphate) is formed on a surface of the negative electrode active material.

In the specification, the “nonaqueous electrolytic solution secondary battery” means a battery provided with a nonaqueous electrolytic solution (typically, an electrolytic solution containing a support salt in a nonaqueous solvent) that shows a liquid state at room temperature (25° C., for example). Further, the “lithium ion secondary battery” means a secondary battery where, by making use of lithium ions as the support salt, charge/discharge is realized by migration of lithium ions between positive and negative electrodes. Further, “substantially” is an expression used for a main structure of the coat containing phosphorus atoms. Typically, it is a term indicating that 80% by mol or more (preferably 85% by mol or more, more preferably 90% by mol or more) of the coat containing the phosphorus atoms is derived from the fluorine-containing phosphate compound (typically, difluorophosphate containing difluorophosphate ion, for example, lithium difluorophosphate). In other words, it means that the coat containing phosphorus atoms can allow inclusion of, other than the compound derived from the fluorine-containing phosphate compound, for example, decomposition products of other components (support salt, for example) constituting the nonaqueous electrolytic solution.

### <<Manufacture of Nonaqueous Electrolytic Solution Secondary Battery>>

The nonaqueous electrolytic solution secondary battery having the negative electrode provided with such a coat as described above can be manufactured according to a manufacturing method including, for example, the following steps. (S10; Housing step) An electrode body provided with the positive electrode having the positive electrode active material and the negative electrode having the negative electrode active material is housed in the battery case. (S20; Injection step) The nonaqueous electrolytic solution in which the fluorine-containing phosphate compound as a phosphorus-containing coat forming agent is added is injected in the battery case. (S30; Charging step) A charging is carried out between the positive electrode and the negative electrode to form a coat containing phosphorus (P) atoms derived from the fluorine-containing phosphate compound on a surface of the negative electrode active material. Hereinafter, the respective steps will be sequentially described.

### <<S10; Housing Step>>

First, the negative electrode having the negative electrode active material, and the positive electrode having the positive electrode active material are prepared.

### <Negative Electrode>

The negative electrode can be preferably prepared by imparting a paste-like or a slurry-like composition (negative electrode active material slurry) obtained by dispersing the negative electrode active material and a binder used as required in an appropriate solvent on a sheet-like negative electrode current collector for example, and by drying. As the solvent, any of aqueous solvents and organic solvents can be used, for example, water can be used.

As the negative electrode current collector, a conductive material made of metal (copper, nickel, for example) having excellent conductivity can be preferably used. A shape of the current collector is not particularly limited because it is different depending on a shape of a structured battery. A battery having a wound electrode body described below mainly uses a foil-like body. A thickness of the foil-like body is not particularly limited. However, it can be usually 5 μm to 50 μm (typically 8 μm to 30 μm) according to the balance between a capacity density of the battery and the strength of the current collector.

As the negative electrode active material, one kind or two or more kinds of materials generally used in nonaqueous electrolytic solution secondary batteries can be used without particular limitation. As preferable materials among these, graphite-based carbon materials (typically graphite particles) can be used. Since such materials can have a reduction potential (vs. Li/Li⁺) of about 0.5 V or less, more preferably 0.2 V or less (0.1 V or less, for example), a higher energy density can be realized. Since the graphite has the crystallinity higher than those of other negative electrode active materials, it tends to decompose the nonaqueous electrolytic solution (carbonate-based nonaqueous solvents, for example), and the endurance of the battery may be thereby degraded. Therefore, application of the technology disclosed here is particularly advantageous. Alternatively, the graphite particles may be particles coated (covered) with an amorphous carbon material. The graphite particles at least a part of a surface of which is coated with an amorphous carbon film can be prepared, for example, by mixing the graphite particles with pitch and firing the mixture. Such particles have a surface coated with the amorphous carbon material; accordingly, the reactivity with the nonaqueous electrolytic solution is held relatively low. Therefore, a battery that uses such particles as the negative electrode active material can provide high endurance.

Properties of the negative electrode active material (typically graphite) are not particularly limited. Usually, the negative electrode active material is in a particulate state having an average particle size of about 0.5 μm to 30 μm (typically, 0.5 μm to 20 μm, or 1 μm to 15 μm, for example, 4 μm to 10 μm). The specific surface area of the negative electrode active material particles (typically, graphite particles) is usually appropriately about 0.1 m²/g to 30 m²/g, typically 0.5 m²/g to 20 m²/g or 1 m²/g to 20 m²/g. For example, the negative electrode active material particles having the specific surface area in the range of about 1 m²/g to 10 m²/g can be preferably used. The tap density of the negative electrode active material particles (typically, graphite particles) is usually about 0.1 g/cm³ to 1.5 g/cm³, typically, 0.5 g/cm³ to 1.3 g/cm³. For example, the negative electrode active material particles having the tap density of about 0.7 g/cm³ to 1.2 g/cm³ can be preferably used. When the properties of the negative electrode active material are within the above range, a dense and highly conductive negative electrode active material layer can be prepared, and high energy density can be realized. Further, appropriate voids can be held within the negative electrode active material layer. Therefore, the nonaqueous electrolytic solution and the phosphorus-containing coat forming agent (fluorine-containing phosphate compound) can readily be soaked, and the Mₚ/C_{dl} ratio disclosed here can be properly satisfied thereby. Therefore, the battery having reduced internal resistance and excellent battery performance (energy density and input/output characteristics, for example) can be realized.

The “average particle size” in the specification means a particle diameter corresponding to a 50% cumulative diameter from a fine particle side (namely, 50% volume average particle size, also called as a median diameter) in a particle size distribution based on volume measured by laser diffraction/scattering method using a general particle size distribution analyzer (type “LA-920” manufactured by Horiba Ltd., for example). Further, in the specification, the “specific surface area” means a surface area measured by a BET method (BET one-point method, for example) with nitrogen gas using a general specific surface area analyzer (BELSORP (trademark)-18PLUS manufactured by BELL Japan Inc., for example). Further, the “tap density” in the specification means a density measured by a method stipulated in JISK1469 using a general tapped density analyzer (model “TPM-3” manufactured by Tsutsui Scientific Instruments Co., Ltd., for example).

As the binder, a polymer that can be dissolved or dispersed in a used solvent can be used. In the negative electrode active material slurry that uses an aqueous solvent, for example, cellulose-based polymers such as carboxy methylcellulose (CMC; typically, sodium salt); and rubbers such as styrene butadiene rubber (SBR) can be preferably used. Further, in the negative electrode active material slurry that uses a nonaqueous solvent, halogenated vinyl resins such as polyvinylidene fluoride (PVdF); and polyalkylene oxide such as polyethylene oxide (PEO) can be preferably adopted.

A ratio of the negative electrode active material in an entire negative electrode active material layer is adequately set to about 50% by mass or more, preferably 90% by mass to 99% by mass (95% by mass to 99% by mass, for example). When the binder is used, a ratio of the binder in an entire negative electrode active material layer can be set to about 1% by mass to 10% by mass, and usually it can be adequately set to about 1% by mass to 5% by mass.

A basis weight of the negative electrode active material layer disposed per unit area of the negative electrode current collector (total basis weight of both sides in a structure that has the negative electrode active material layer on both sides of the negative electrode current collector) may be, for example, about 5 mg/cm² to 20 mg/cm² (typically, 5 mg/cm² to 10 mg/cm²). In a structure that has the negative electrode active material layer on both sides of the negative electrode current collector, a basis weight of the negative electrode active material layer disposed on each surface of the negative electrode current collector is preferably roughly the same. The density of the negative electrode active material layer can be about 0.5 g/cm³ to 2 g/cm³ (typically, 0.9 g/cm³ to 1.5 g/cm³), for example. Such a density can be controlled by rolling using a press machine, for example. In the battery disclosed here, by reflecting various design parameters, a coat having suitable amount of the negative electrode active material can be formed on a surface of the negative electrode active material. Therefore, even when parameters such as the basis weight and the electrode density are changed, such changes can be flexibly handled, and a battery having excellent endurance and input/output characteristics can be realized thereby.

The capacitance of the negative electrode active material layer C_{dl} is not particularly limited. However, typically, it is 0.1 mF/cm² to 0.5 mF/cm², and can be 0.2 mF/cm² to 0.3 mF/cm², for example. When such a range is satisfied, the range of Mₚ/C_{dl} ratio disclosed here can be properly realized. The capacitance of the negative electrode active material layer C_{dl} can be controlled by physical properties of the used negative electrode active material (specific surface area and pore volume, for example) and properties of the negative electrode active material layer (basis weight and density, for example), for example. As a general tendency, the larger any one of values of the physical properties of the specific surface area, the tap density, and the pore volume of the negative electrode active material used becomes, the larger the value of the capacitance of the negative electrode active material layer C_{dl} becomes. Further, the higher the density of the negative electrode active material layer is made, the smaller a value of the capacitance of the negative electrode active material layer C_{dl} becomes.

The capacitance of the negative electrode active material layer C_{dl} (mF/cm²) can be measured using an AC impedance method, for example. A measurement method of the AC impedance is not particularly limited. For example, a method that uses a frequency response analyzer (FRA), digital methods such as a digital Fourier integration method, and a fast Fourier transformation method by noise input, and analogue methods such as a Lissajous method and an AC bridge method can be appropriately adopted. Specifically, the capacitance can be obtained by a measurement method including, for example, the following steps. (1) An electric double layer capacitor cell (symmetry cell) is formed. (2) A measurement is conducted by an AC impedance method. (3) A capacitance C_{dl} is calculated.

In the above measurement method, two sheets of negative electrodes in unused (before charging) state are prepared. The negative electrodes each has a form where the negative electrode active material layer is adhered to one surface of the negative electrode current collector. Further, the negative electrode active material layers formed on two sheets of negative electrodes have the same properties (basis weight and density, for example) and areas with each other. These two sheets of negative electrodes (electrodes) are disposed in a cell so that the negative electrode active material layers face each other via the separator. A predetermined nonaqueous electrolytic solution is injected therein to form a so-called electric double layer capacitor cell (symmetry cell). Subsequently, under a temperature environment of 25° C., current collectors of the both electrodes are electrically connected to conduct an AC impedance measurement. In the AC impedance measurement, while changing a frequency, an AC voltage (or AC current) signal is input between two sheets of electrodes to measure a response current (or response current) during the input. By comparing an inputted sinusoidal wave and a response signal, a transfer function (impedance) of an electrode reaction can be obtained. Subsequently, frequency characteristics of the obtained impedances are expressed in a so-called Cole-Cole plot (Nyquist plot). Then, by approximating an arc shape that reflects a reaction resistance R_{ct} and an electric double layer capacitance C_{dl} of the electrode with a semi-circle, using a general formula (or a commercially available calculation program) based on the impedance theory, a capacitance per unit area C_{dl} can be calculated. In the specification, the “capacitance C_{dl}” means a value at a frequency of 0.1 Hz.

As the separator and nonaqueous electrolytic solution used for forming the symmetry cell, the same as those used in the general nonaqueous electrolytic solution secondary battery can be adopted by appropriately selecting. Further, the impedance measurement device can be optionally selected from generally used devices. As long as 0.1 Hz is included, a measurement frequency range can be set to, for example, about 100 kHz to 0.1 Hz. Alternatively, a measurement can be performed also with the frequency fixed at 0.1 Hz.

Here, a measurement method that uses the AC impedance method is shown above. However, using, other than the above, a general method known as a capacitance measurement method of an electric double layer capacitor (so-called a constant current discharge method or a constant resistance discharge method, for example), the capacitance of the negative electrode active material layer C_{dl} can be measured.

Further, the capacitance of the negative electrode active material layer C_{dl} provided to the battery after charging can be measured as shown below, for example. Firstly, the battery is, after discharging under a constant current up to 2.5 V to approach a complete discharge state, disassembled, and the negative electrode is taken out. Next, two sheets of negative electrodes are cut out from the negative electrode, and an electric double layer capacitor cell (symmetry cell) is formed therewith. The cell is evaluated in the same manner as the above, thereby allowing calculation of the capacitance C_{dl} (mF/cm²) the same as that of the unused negative electrode.

### <Positive Electrode>

The positive electrode is not particularly limited as long as it has a positive electrode active material that can store and release charge carriers. However, typically, it includes a positive electrode current collector and a positive electrode active material layer containing at least a positive electrode active material formed on the positive electrode current collector. The positive electrode like this can be preferably prepared by imparting a paste-like or slurry-like composition (positive electrode active material slurry) obtained by dispersing the positive electrode active material and the binder and conductive agent used as required in an adequate solvent on a sheet-like positive electrode current collector, and by drying that. As the solvent, both of aqueous solvents and organic solvents can be used. For example, N-methyl-2-pyrolidone (NMP) can be used. As the positive electrode current collector, conductive members made of metals having good conductivity (aluminum, nickel, titanium, and stainless steel, for example) can be preferably used. Further, a shape of the positive electrode current collector may be the same as that of the negative electrode current collector.

As the positive electrode active material, one or more kinds of substances generally used for nonaqueous electrolytic solution secondary batteries can be used without particular limitation. For example, lithium transition metal compounds having a layered structure or a spinel structure, which contains lithium and at least one kind of transition metal element as a constituent metal element; polyanion type (olivine type, for example) lithium ion transition metal compounds; and so on can be used.

Properties of such a positive electrode active materials are not particularly limited. Usually, the positive electrode active material is preferably in a particulate state having an average particle size of 0.5 μm to 20 μm (typically, 1 μm to 15 μm, for example, 2 μm to 10 μm). Further, a specific surface area of the positive electrode active material is usually adequate to be about 0.1 m²/g to 30 m²/g, typically 0.2 m²/g to 10 m²/g, for example, about 0.5 m²/g to 3 m²/g can be preferably adopted. When the properties of the positive electrode active material are within the above range, a dense positive electrode active material layer having high conductivity can be prepared. Further, since appropriate voids can be held within the positive electrode active material layer, the nonaqueous electrolytic solution can readily soak therein, and the internal resistance can be reduced thereby.

As the binder, an appropriate polymer can be selected from the polymer materials exemplified as the binder for the negative electrode active material layer. Specifically, polyvinylidene fluoride (PVdF), polyvinylidene chloride (PVdC), and polyethylene oxide (PEO) can be exemplified. As the conductive agent, for example, carbon materials can be used. More specifically, one kind or two or more kinds selected from the carbon materials such as various carbon black (acetylene black, and Ketjen black, for example), cokes, activated carbon, graphite, carbon fibers (PAN-based carbon fiber, and pitch-based carbon fiber), carbon nanotubes, fullerene, and graphene can be used. Among these, carbon black having a relatively small average particle size and a large specific surface area (typically, acetylene black) can be preferably used. Other than the above, various kinds of additive agents such as dispersants can be appropriately used.

A ratio of the positive electrode active material in an entire positive electrode active material layer can be appropriately set to about 60% by mass or more (typically, 60% by mass to 99% by mass). Usually, it is preferably set to about 70% by mass to 95% by mass. When the binder is used, a ratio of the binder in an entire positive electrode active material layer can be set to, for example, about 0.5% by mass to 10% by mass, usually preferably to about 1% by mass to 5% by mass. When the conductive agent is used, a ratio of the conductive agent in the entire positive electrode active material layer can be set to, for example, about 2% by mass to 20% by mass, usually preferably to about 3% by mass to 10% by mass.

A basis weight of the positive electrode active material layer disposed per unit area of the positive electrode current collector (total basis weight of both sides in a structure that has the positive electrode active material layer on both sides of the positive electrode current collector) may be, for example, about 5 mg/cm² to 40 mg/cm² (typically, 10 mg/cm² to 20 mg/cm²). In a structure that has the positive electrode active material layer on both sides of the positive electrode current collector, a basis weight of the positive electrode active material layer disposed on each surface of the positive electrode current collector is usually preferably set to a roughly same level. The density of the positive electrode active material layer can be, for example, about 1.5 g/cm³ to 4 g/cm³ (typically, 1.8 g/cm³ to 3 g/cm³). When the density of the positive electrode active material layer is set in the above range, while maintaining a desired capacitance, the diffusion resistance of lithium ions can be suppressed low. Therefore, the input/output characteristics and the energy density can be combined at a higher level.

### <Electrode Body>

Subsequently, the prepared positive electrode and negative electrode are laminated to prepare an electrode body. In a typical structure of the nonaqueous electrolytic solution secondary battery disclosed here, a separator is interposed between the positive electrode and negative electrode. As the separator, various kinds of porous sheets the same as those used in general nonaqueous electrolytic solution secondary batteries can be used. For example, porous resin sheets (films and nonwoven fabrics) made of resins such as polyethylene (PE), polypropylene (PP), polyester, cellulose and polyamide can be used. Such a porous resin sheets may have a single layer structure or a multi-layer structure of two or more layers (for example, three-layer structure where on each of both side of a PE layer, a PP layer is laminated). Further, a structure having a porous heat-resistant layer on one side or both sides of the porous sheet or nonwoven fabric (typically, one side) can be used. A thickness of the separator is preferably set in the range of, for example, about 10 μm to 40 μm.

### <Battery Case>

Then, the above-prepared electrode body is housed in a predetermined battery case. As the battery case, materials and shapes used generally in the nonaqueous electrolytic solution secondary batteries can be used. As the materials of the case, metal materials such as aluminum and steel; and resin materials such as polyphenylene sulfide resins and polyimide resins can be used. Among these, from the viewpoint of enhancing heat dissipation property and energy density, relatively light metals (aluminum and aluminum alloys, for example) can be preferably adopted. Further, a shape of the case (external shape of a container) is not particularly limited. For example, circular (cylindrical, coin, and button), hexahedron (cuboid and cube), and bag shapes, and processed and modified shapes thereof can be used. Further, the case may be provided with a safety mechanism such as a current breaking mechanism (a mechanism that can break a current in response to a rise of internal pressure during overcharging of a battery).

### <<S20; Injection Step>>

Here, the nonaqueous electrolytic solution in which the fluorine-containing phosphate compound as the phosphorus-containing coat forming agent is added is injected in the battery case, the electrode body is perfused therewith. In this case, an addition amount of the fluorine-containing phosphate compound is determined so that a ratio of an amount of phosphorus atoms per unit area of the negative electrode active material layer Mₚ with respect to a capacitance per unit area of the negative electrode active material layer C_{dl}(Mₚ/C_{dl} ratio) may be within the range of 0.79 μmol/mF≦Mₚ/C_{dl}≦1.21 μmol/mF. As will be shown also in an experimental example described below, the addition amount of the fluorine-containing phosphate compound and a coat amount formed on a surface of the negative electrode active material (in other words, an amount of phosphorus atoms per unit area of the negative electrode active material layer, Mₚ) are in a generally good proportional relationship. Therefore, a preferable addition amount can be assessed by carrying out a simple preliminary study in advance. For example, with several sheets of negative electrode provided with a negative electrode active material layer having the same capacitance prepared, some nonaqueous electrolytic solution secondary batteries different only in the addition amount of the fluorine-containing phosphate compound are prepared. After a predetermined charging is applied to the batteries, the batteries are disassembled and the negative electrodes are taken out, and coat amounts formed on the negative electrode active material layer are measured. Then, based on a graph showing a relationship between the addition amount of the fluorine-containing phosphate compound and the coat amount formed on the negative electrode active material layer, the addition amount of the fluorine-containing phosphate compound properly satisfying the Mₚ/C_{dl} ratio can be determined. Now, here, a method of adding the fluorine-containing phosphate compound to the nonaqueous electrolytic solution is shown as an example. However, without limiting thereto, for example, also a method of directly adding and impregnating that in the electrode body (typically, negative electrode active material layer or separator) can be adopted.

### <Nonaqueous Electrolytic Solution>

As the nonaqueous electrolytic solution, a nonaqueous electrolytic solution where a support salt (a lithium salt in the lithium ion secondary battery) is dissolved or dispersed in a nonaqueous solvent can be preferably adopted. The support salt same as those of the general nonaqueous electrolytic solution secondary battery can be appropriately selected and adopted. For example, lithium salts such as LiPF₆, LIBF₄, LiClO₄, LiAsF₆, Li(CF₃SO₂)₂N, and LiCF₃SO₃ can be used. These support salts can be used alone or in combinations of two or more kinds. As the particularly preferred support salt, LiPF₆ can be used. When LiPF₆ is contained in the nonaqueous electrolytic solution, in the same manner as the case where the phosphorus-containing coat forming agent is contained, LiPF₆ is decomposed in a charge step described below, and a coat containing phosphorus atoms can be formed on a surface of the negative electrode active material. However, as will be shown also in an experimental example shown below, a coat amount derived from LiPF₆ is relatively very low. Further, according to an analysis by ion exchange chromatography or the like, phosphorus derived from LiPF₆ and phosphorus derived from the fluorine-containing phosphate compound can be distinctively recognized.

A concentration of the support salt is not particularly limited. However, when it is extremely low, since an amount of charge carriers (typically, lithium ions) contained in the nonaqueous electrolytic solution is deficient, the ion conductivity tends to degrade. On the other hand, when such a concentration is extremely high, since the viscosity of the nonaqueous electrolytic solution becomes high in a temperature range of room temperature or less (0° C. to 30° C., for example), the ion conductivity tends to degrade. Therefore, the nonaqueous electrolytic solution is preferably prepared so that the concentration of the support salt may be in the range of 0.7 mol/L to 1.3 mmol/L.

As the nonaqueous solvent, organic solvents such as various kinds of carbonates, ethers, esters, nitrites, sulfones, and lactones used in electrolytic solutions for general nonaqueous electrolytic solution secondary batteries can be used without particular limitation. The “carbonates” mean that those include ring carbonates and chain carbonates. The “ethers” mean that those include ring ethers and chain ethers. Specifically, ethylene carbonate (EC), propylene carbonate (PC), diethyl carbonate (DEC), dimethyl carbonate (DMC), ethyl methyl carbonate (EMC), vinylene carbonate (VC), 1,2-dimethoxyethane, 1,2-diethoxyethane, tetrahydrofuran, 2-methyltetrahydrofuran, dioxane, 1,3-dioxolan, diethylene glycol dimethyl ether, ethylene glycol dimethyl ether, acetonitrile, propionitrile, nitromethane, N,N-dimethyl formamide, dimethyl sulfoxide, sulfolane, and γ-butyrolactone can be exemplified. Such nonaqueous solvents can be used alone or in appropriate combinations of two or more kinds thereof.

As a preferable aspect, a nonaqueous solvent mainly containing carbonates can be used. When such a nonaqueous solvent is used as the electrolytic solution, in the charge step described below, an excellent coat can be formed on a surface of the negative electrode active material. Among these, EC having high relative permittivity, and DMC and EMC having high oxidation potential (having a broad potential window) and the like can be preferably used. For example, a nonaqueous solvent that contains one or more kinds of carbonates as a nonaqueous solvent and in which a total volume of the carbonates is 60% by volume or more (more preferably 75% by volume or more, still more preferably 90% by volume or more, may be substantially 100% by volume) in a volume of an entire nonaqueous solvents can be preferably used.

### <Phosphorus-Containing Coat Forming Agent>

As the phosphorus-containing coat forming agent, for example, a compound that contains fluorine and phosphorus as constituent elements, that is, a fluorine-containing phosphate compound can be used. As suitable examples, various kinds of salts having a monofluorophosphate anion (PO₃F⁻) (that is, monofluorophosphate), and various kinds of salts having a difluorophosphate anion (PO₂F₂⁻) (that is, difluorophosphate) can be used. A cation in the monofluorophosphate and difluorophosphate (counter cation) may be either of an inorganic cation and an organic cation. Specific examples of the inorganic cation include cations of alkali metals such as Li, Na, and K; cations of alkali earth metals such as Be, Mg, and Ca; and so on. Specific examples of the organic cations include ammonium cations such as tetraalkyl ammonium, and trialkyl ammonium. Specific examples of the fluorine-containing phosphate compounds include monofluorophosphates such as lithium monofluorophosphate (Li₂PO₃F), sodium monofluorophosphate (Na₂PO₃F), and potassium monofluorophosphate (K₂PO₃F); difluorophosphates such as lithium difluorophosphate (LiPO₂F₂), sodium difluorophosphate (NaPO₂F₂), and potassium difluorophosphate (KPO₂F₂). These compounds can be used alone or in appropriate combinations of two or more kinds thereof. These compounds can be electrically decomposed in the charge step described below and can form a coat containing phosphorus atoms on a surface of the negative electrode active material. Such fluorine-containing phosphate compounds can be prepared according to a well-known method or can be purchased as commercially available products.

Although not particularly limited, a concentration of the phosphorus-containing coat forming agent (typically, a fluorine-containing phosphate compound, for example, lithium difluorophosphate) in the nonaqueous electrolytic solution can be set to, usually, 0.01 mol/L to 0.2 mol/L, typically, 0.05 mol/L to 0.15 mol/L, for example, 0.05 mol/L to 0.09 mol/L or 0.08 mol/L to 0.13 mol/L. When the content of the fluorine-containing phosphate compound is less than 0.01 mol/L, a sufficient amount the phosphorus atom-containing coat may not be formed on a surface of the negative electrode (typically, negative electrode active material). Further, when the content of the fluorine-containing phosphate compound is larger than 0.2 mol/L, the coat is formed in excess on a surface of the negative electrode (typically, negative electrode active material), and the resistance of the negative electrode may increase.

An amount of the fluorine-containing phosphate compound used for forming the battery (in other words, amount of the fluorine-containing phosphate compound supplied into the battery case) can be grasped according to methods such as by quantitatively measuring amounts of PO₂F₂ ions, PO₃F ions and PO₄ ions contained in the positive and negative electrode active material layers by, for example, ion exchange chromatography; and by quantitatively measuring chemical species derived from the fluorine-containing phosphate compound and decomposition products thereof by analyzing the nonaqueous electrolytic solution remaining in the battery case using ion exchange chromatography; and so on.

According to the nonaqueous electrolytic solution containing such a phosphorus-containing coat forming agent, a strong and dense coat can be properly formed on a surface of the negative electrode active material. Therefore, an effect of the invention can be exerted at a higher level.

### <<S30; Charging Step>>

Here, a charging is conducted between the positive electrode and the negative electrode of the battery after the injection step (S20). The phosphorus-containing coat forming agent (fluorine-containing phosphate compound) is electrically decomposed on a surface of the negative electrode or in the vicinity thereof. Then, when the decomposition products attach (deposition, adsorption, or the like) to the negative electrode active material, a coat containing phosphorus atoms is formed on a surface of the negative electrode active material. In the coat, other than components derived from the fluorine-containing phosphate compound, decomposition products of other components constituting the nonaqueous electrolytic solution (support salt and nonaqueous solvent, for example) can be contained.

A voltage between the positive and negative electrode terminals in the charging (typically, maximum reaching voltage) is different also depending on, for example, a kind of a used electrode material (active material), and constituent components of the nonaqueous electrolytic solution, and the like. However, the voltage has to be set so that at least a potential of the negative electrode may be lower than a potential at which the fluorine-containing phosphate compound can be decomposed (reduction decomposition potential (vs. Li/Li⁺)). Further, when the potential of the positive electrode is too high, an oxidation decomposition reaction of the nonaqueous electrolytic solution is promoted, that is, the battery performance can be adversely affected. Accordingly, the voltage between the positive and negative electrode terminals in the charging (typically, maximum reaching voltage) is typically preferably set to a degree that does not largely exceed the upper limit voltage of the battery. In a battery where a voltage between terminals in a SOC 100% is set to, for example, 4.1 V, a charge voltage is preferably set to 2 V or more and 4.5 V or less (typically, 3.5 V or more and 4.2 V or less).

When a voltage is adjusted, a constant current charge (CC charge) may be conducted, where a charging is conducted at a constant current from the start of charge until the voltage between the positive and negative electrode terminals reaches a predetermined value. Alternatively, the voltage may be adjusted by constant current and constant voltage charge (CCCV charge) where constant current charge is conducted from the start of charge until the voltage between the positive and negative electrode terminals reaches a predetermined value, further, charge is conducted at a constant voltage for a predetermined time. Usually, the CCCV charging method can be preferably adopted. The fluorine-containing phosphate compound can be preferably decomposed thereby, and a strong and dense coat can be stably formed on a surface of the negative electrode active material. A charging rate during the CC charge (possively during the CC charge in the CCCV charging method) is not particularly limited and can be set to, for example, about 1/50 C to 5 C (1 C is a value of a current that can conduct full charge/discharge for 1 hour). Usually, the charging rate is suitably set to about 1/30 C to 2 C (1/20 C to 1 C, for example). When the charging rate is too small, a charging efficiency tends to degrade. Further, when the charging rate is too large, the positive electrode active material may be degraded, and the uniformity of the coat formed may be degraded. The charging can be conducted once or a charging/discharging operation may be repeated, for example, two or more times. Further, within the range that does not largely adversely affect on the battery performance, other operations (loading of pressure by constraint or irradiation of ultrasonic, for example) can be conducted together.

In the battery disclosed here, the coat containing phosphorus (P) atoms (substantially, the coat derived from a fluorine-containing phosphate compound, typically the coat derived from difluorophosphate, for example the coat derived from lithium difluorophosphate) is formed on a surface of the negative electrode active material. Such a coat may have a form of a compound that contains, for example, PO₂F₂ ion, PO₃F ion, or PO₄ ion as a constituent element. Further, an amount of phosphorus atoms contained in the coat is not particularly limited. However, it is typically 0.1 μmol/cm² to 0.5 μmol/cm², for example, it can be 0.2 μmol/cm² to 0.3 μmol/cm². When such a range is satisfied, the range of the Mₚ/C_{dl} ratio disclosed here can be properly realized.

The coat derived from difluorophosphate is dense and excellent also in thermal stability, that is, high in quality. Therefore, an interface with the nonaqueous electrolytic solution can be more stabilized, and more excellent battery performance can be enabled thereby. For example, a nonaqueous electrolytic solution secondary battery that can provide excellent input/output characteristics over a long term even under high temperature environment can be realized.

The amount of phosphorus atoms contained in the coat Mₚ (μmol/cm²) can be measured by general ion exchange chromatography. More specifically, a measurement specimen is sampled from the negative electrode active material layer, and using an appropriate solvent, ions that are a measurement target are extracted. Next, such a solution is used for a measurement by ion exchange chromatography, and from the obtained result, amounts (μmol) of PO₂F₂ ions, PO₃F ions, and PO₄ ions are respectively quantified. Then, by summing up these values, by further dividing the resulted value with an area (cm²) of the negative electrode active material layer used for measurement, the amount of phosphorus atoms Mₚ (μmol/cm²) can be obtained. According to such an analysis, even in the battery that uses the nonaqueous electrolytic solution containing LiPF₆ as the support salt, existence of phosphorus derived from the fluorine-containing phosphate compound (typically, difluorophosphate, for example, LiPO₂F₂) can be distinctively recognized from phosphorus derived from LiPF₆.

Here, as a measurement method of the amount of phosphorus atoms contained in the coat Mₚ, ion exchange chromatography was used. However, the measurement method is not limited thereto. Also using, for example, well-known inductively coupled plasma atomic emission spectroscopy (ICP-AES), mass spectrometry (MS), and X-ray absorption fine structure (XAFS), in the same manner, the amount of phosphorus atoms contained in the coat can be grasped.

In the negative electrode of the nonaqueous electrolytic solution secondary battery disclosed here, a ratio of the amount of phosphorus atoms per 1 cm² of the negative electrode active material layer Mₚ (μmol/cm²) with respect to the capacitance per 1 cm² of the negative electrode active material layer (mF/cm²) C_{dl} (Mₚ/C_{dl} ratio) is 0.79 to 1.21. When the Mₚ/C_{dl}≧0.79 (preferably, Mₚ/C_{dl}≧0.8, more preferably Mₚ/C_{dl}≧0.9) is satisfied, an interface between the negative electrode active material and the nonaqueous electrolytic solution can be stabilized. Therefore, in the charge/discharge after that, the nonaqueous electrolytic solution can be preferably hindered from being decomposed. Further, when the Mₚ/C_{dl}≦1.21 (preferably Mₚ/C_{dl}≦1.1, more preferably Mₚ/C_{dl}≦1) is satisfied, the coat can be hindered from excessively growing. Therefore, an increase in the resistance accompanying formation of the coat can be hindered. In the battery provided with such a coat, charge carriers can be more smoothly migrated compared with general batteries, and excellent input/output characteristics can be provided. When the Mₚ/C_{dl} ratio is in the above range, a nonaqueous electrolytic solution secondary battery that can combine the endurance (particularly high temperature endurance) and the input/output characteristics at a high level can be realized.

In the nonaqueous electrolytic solution secondary battery disclosed here, almost all of the added fluorine-containing phosphate compound is decomposed on a surface of the negative electrode active material by a charging (typically, initial charging) and can be consumed for forming the coat containing phosphorus atoms on a surface of the negative electrode active material. Therefore, in the invention, in a battery left for a long time after the construction of the battery (a battery after the charging, for example), it is not necessary for the fluorine-containing phosphate compound itself to remain in the nonaqueous electrolytic solution.

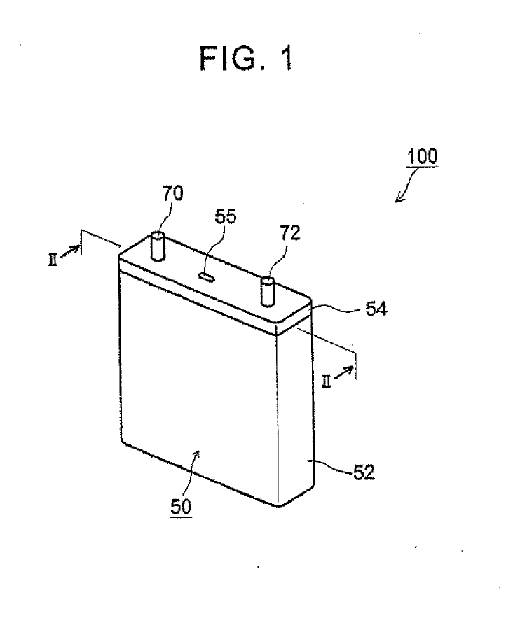

Although not intended to limit particularly, as a schematic configuration of a nonaqueous electrolytic solution secondary battery according to one embodiment of the invention, with a nonaqueous electrolytic solution secondary battery (unit cell) having a form that houses a flatly wound electrode body (wound electrode body) and a nonaqueous electrolytic solution in a flat cuboid (rectangle) case as an example, its schematic configuration is shown in FIGS. 1 to 3. In the following drawings, members and portions having like functions are denoted by like numbers, and duplicated descriptions may be omitted or simplified. Dimensional relationships (length, width, thickness, and the like) in the respective drawings do not reflect actual dimensional relationships.

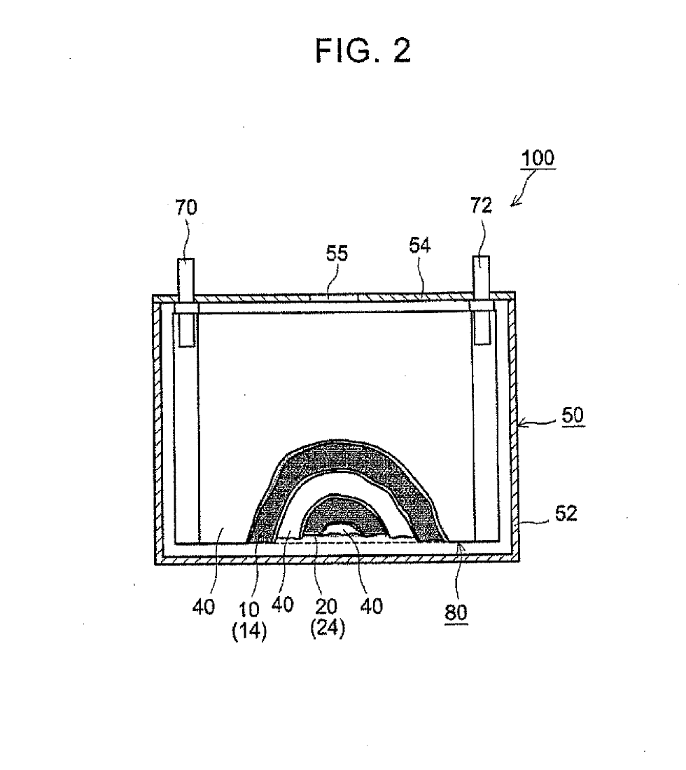

The nonaqueous electrolytic solution secondary battery according to one embodiment of the technology disclosed here has, as shown in, for example, FIGS. 1 and 2, a structure where a wound electrode body 80 is, together with a not shown nonaqueous electrolytic solution, housed in a flat and cuboid-like (rectangular) battery case 50 corresponding to a shape of the electrode body 80. The battery case 50 includes a flat and cuboid-like (rectangular) battery case body 52 opened at an upper end and a cap body 54 that clogs an opening thereof. On a top surface of the battery case 50 (that is, cap body 54), a positive electrode terminal 70 and a negative electrode terminal 72 for external connection are disposed so that a part of these terminals protrudes outward from the cap body 54. Further, the cap body 54 is provided with a safety valve 55 for discharging a gas generated inside of the battery case outside of the battery case. A nonaqueous electrolytic solution secondary battery 100 having such a configuration houses, for example, the electrode body 80 from the opening of the case 50 inside thereof, and the cap body 54 is attached to the opening of the case 50. Thereafter, the nonaqueous electrolytic solution is injected from a not shown electrolytic solution injecting hole disposed to the cap body 54, and the injecting hole is then clogged.

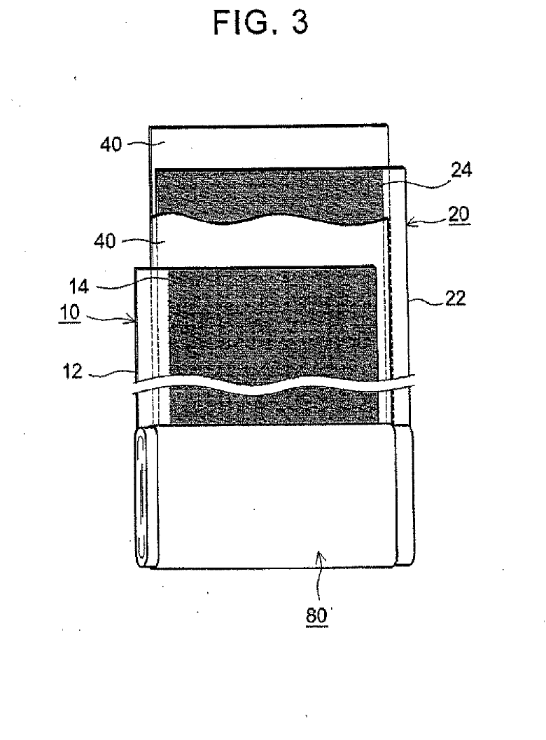

FIG. 3 is a diagram schematically showing a long sheet structure (electrode sheet) in the step before the wound electrode body 80 is assembled. The wound electrode body 80 includes a positive electrode sheet 10 where a positive electrode active material layer 14 is formed along a longitudinal direction on one side or both sides (typically on both sides) of a long positive electrode current collector 12, and a negative electrode sheet 20 where a negative electrode active material layer 24 is formed along a longitudinal direction on one side or both sides (typically on both sides) of a long negative electrode current collector 22. These positive electrode sheet 10 and negative electrode sheet 20 are superposed and wound, the resulted wound body is depressed from a side surface direction to crush, and the wound electrode body 80 is molded flat thereby. Between the positive electrode active material layer 14 and negative electrode active material layer 24, an insulating layer is placed to hinder the both from coming into direct contact. In an example shown here, when the wound electrode body 80 is prepared, a long sheet separator 40 is used as the insulating layer. In this example, a width of the negative electrode active material layer 24 is a little larger than that of the positive electrode active material layer 14. Further, the width of the separator 40 is a little larger than that of the negative electrode active material layer 24.

The positive electrode sheet 10 has one end part along its longitudinal direction, in which the positive electrode active material layer 14 is not disposed (or removed) and the positive electrode current collector 12 is exposed. In the same manner, the negative electrode sheet 20 has one end part along its longitudinal direction, in which the negative electrode active material layer 24 is not disposed (or removed) and the negative electrode current collector 22 is exposed. Then, a positive electrode current collector plate and a negative electrode current collector plate, respectively, are attached to the exposed end part of the positive electrode current collector 12 and the exposed end part of the negative electrode current collector 22. Further, the positive electrode current collector plate and the negative electrode current collector plate are electrically connected respectively with the positive electrode terminal 70 (FIG. 2) and the negative electrode terminal 72 (FIG. 2).

Further, according to one embodiment of the invention, a battery pack where a plurality of the nonaqueous electrolytic solution secondary batteries (unit cells) disclosed here is combined is provided. In the battery pack obtained by connecting a plurality of unit cells with each other (typically, in series), entire performance can depend on the unit cell having the poorest performance among the constituting unit cells. The nonaqueous electrolytic solution secondary battery disclosed here has higher reliability and excellent endurance and input/output characteristics than general batteries; accordingly, as the battery pack, a higher battery performance can be enabled.

The nonaqueous electrolytic solution secondary battery disclosed here (typically, lithium ion secondary battery) can be used in various kinds of applications. The secondary battery is characterized in that the fluorine-containing phosphate compound addition effect is suitably exerted and a battery performance (for example, endurance and input/output characteristics) is more excellent than that of general batteries. Therefore, using such performance, it can be suitably used as a driving power source mounted on, for example, vehicles. The vehicle is typically an automobile and can be, for example, a hybrid vehicle (HV), a plug-in hybrid vehicle (PHV), an electric vehicle (EV), a fuel cell vehicle, an electric wheelchair, and an electric assist bicycle. Therefore, as another aspect of one embodiment of the invention, a vehicle provided with any of the nonaqueous electrolytic solution secondary batteries (preferably, as a power source) disclosed here can be provided. The vehicle can be provided with a plurality of nonaqueous electrolytic solution secondary batteries in a form of, typically, a battery pack where the plurality of secondary batteries are connected in parallel.

According to a method of manufacturing the nonaqueous electrolytic solution secondary battery according to one embodiment of the technology disclosed here, the fluorine-containing phosphate compound is decomposed and the coat having low resistance and high quality (for example, high thermal stability) can be preferably formed on the surface of the negative electrode active material. Therefore, the nonaqueous electrolytic solution secondary battery that can combine the endurance and the input/output characteristics at a high level can be properly manufactured. Further, by using a capacitance per 1 cm² of the negative electrode active material C_{dl} (mF/cm²) as an index, for example, even when a basis weight or a density of the negative electrode active material layer is changed, such a change can be flexibly handled. In other words, an addition amount of the fluorine-containing phosphate compound that has been likely to be determined depending on experience can be stably controlled to the optimum value. Therefore, compared with a case where a physical property value of the negative electrode active material is used as an index, the coat having the optimum quantity can be stably formed.

Hereinafter, examples relating to the invention will be described. However, it is not intended to limit the invention to such examples.

### <Negative Electrode>

First, as a negative electrode active material, the following three kinds of natural graphite particles were prepared.

(Natural graphite A) average particle diameter: 10 μm, specific surface area: 3.37 m²/g

(Natural graphite B) average particle diameter: 10.2 μm, specific surface area: 3.64 m²/g

(Natural graphite C) average particle diameter: 10.4 μm, specific surface area: 4.38 m²/g

Using the three kinds of graphite, three kinds of negative electrode sheets different only in the kind of the negative electrode active material were prepared.

The natural graphite A as the negative electrode active material, styrene butadiene rubber (SBR) as the binder, and carboxymethylcellulose (CMC) as the dispersant were weighed at a weight ratio thereof of 98:1:1, and put in a kneader. Then, the mixture was kneaded while controlling the viscosity with ion exchanged water so that a solid content concentration may be 45% by mass. Thus, a slurry-like composition was prepared. The slurry was coated on one side of a long copper foil having a thickness of 10 μm (negative electrode current collector) at a basis weight of 7.39 mg/cm². Then, after drying, a rolling was applied using a roll press, and a negative electrode sheet A having a negative electrode active material layer on the negative electrode current collector (total thickness: 72.5 μm, electrode density: 1.18 g/cm³) was prepared.

In the same manner as the case where the natural graphite A was used except that natural graphite B was used as the negative electrode active material, and the slurry was coated so that a basis weight may be 7.37 mg/cm², a negative electrode sheet B (total thickness: 73.2 μm, electrode density: 1.17 g/cm³) was prepared.

In the same manner as the case where the natural graphite A was used except that natural graphite C was used as the negative electrode active material, and the slurry was coated so that a basis weight may be 7.79 mg/cm², a negative electrode sheet C (total thickness: 73.1 μm, electrode density: 1.23 g/cm³) was prepared.

### [Measurement of Capacitance]

Of the three kinds of negative electrode sheets A to C prepared above, capacitance C_{dl} of the negative electrode active material layer was measured using an AC impedance method. Measurement conditions are as shown below.

Electric double layer capacitor cell

Working electrode and counter electrode: from each negative electrode sheet, two sheets of electrode of 45 mm×47 mm (area of negative electrode active material layer: about 21.15 cm²) were prepared.
Nonaqueous electrolytic solution: in a mixed solvent in which ethylene carbonate (EC), dimethyl carbonate (DMC), and ethyl methyl carbonate (EMC) are contained at a volume ratio of EC:DMC:EMC=1:1:1, LiPF₆ was dissolved at 1.0 mol/L.

AC impedance method

Measurement temperature: 25° C.
Measurement device: “Potentio-galvanostat 3287” and “frequency response analyzer (FRA) 1255B” (available from SOLARTRON)
Input voltage: 500 mV
Measurement frequency range: 100 kHz to 0.1 Hz

Calculation and measurement of capacitance

Analysis software: “ZP lot” (available from SOLARTRON)

As a result, the C_{dl} of the negative electrode sheet A, C_{dl} of the negative electrode sheet B, and C_{dl} of the negative electrode sheet C were 0.239 mF/cm², 0.267 mF/cm² and 0.411 mF/cm², respectively.

### <Nonaqueous Electrolytic Solution Secondary Battery>

Using the prepared three kinds of negative electrode sheets, nonaqueous electrolytic solution secondary batteries relating to Example 1 to Example 12 were formed. Firstly, LiNi_{1/3}Co_{1/3}Mn_{1/3}O₂ as the positive electrode active material, acetylene black (AB) as the conductive agent, and polyvinylidene fluoride (PVdF) as the binder were measured at a weight ratio of these materials of 90:8:2, and the mixture was charged in a kneader. Then, the mixture was kneaded while adjusting the viscosity with N-methyl pyrrolidone (NMP) so that a solid content concentration may be 50% by mass. Thus, a slurry composition for a positive electrode active material layer (positive electrode active material slurry) was prepared. The slurry was coated on one side of a long aluminum foil having a thickness of 15 μm (positive electrode current collector) at a basis weight of 12 mg/cm² (based on solid content). Subsequently, after drying, a rolling was conducted using a roll press machine. Thus, the positive electrode sheet having the positive electrode active material layer (electrode density: 2.2 g/cm³) on the positive electrode current collector was prepared.

The positive electrode sheet prepared above and a negative electrode sheet shown in Table 1 were disposed so that the active material layers face each other with a separator sheet interposed therebetween, and an electrode body was prepared. Here, the separator sheet had a three-layer structure in which polypropylene (PP) was laminated on both sides of polyethylene (PE), a thickness of 20 μm, a pore diameter of 0.09 μm, and the porosity of 48% by volume. The prepared electrode body was disposed inside the battery case, and the nonaqueous electrolytic solution, and lithium difluorophosphate (LiPO₂F₂) as the fluorine-containing phosphate compound were injected. Here, as the nonaqueous electrolytic solution, a nonaqueous electrolytic solution obtained by dissolving LiPF₆ as the support salt at a concentration of 1.1 mol/L in a mixed solvent containing ethylene carbonate (EC), dimethyl carbonate (DMC), and ethyl methyl carbonate (EMC) at a volume ratio of EC:DMC:EMC=1:1:1 was used. Lithium difluorophosphate was added in a ratio shown in Table 1 with respect to the nonaqueous electrolytic solution. Then, the positive electrode terminal and the negative electrode terminal were welded to the positive electrode current collector and the negative electrode current collector, which were exposed at the electrode body end part. Thereafter, the battery case was sealed, and the lithium ion secondary batteries relating to Example 1 to Example 12 were formed. Structures of the respective batteries are summarized in Table 1 below. That is, the lithium ion secondary batteries relating to Example 1 to Example 7 are different only in the addition amount of lithium difluorophosphate in the nonaqueous electrolyte solution. Also Example 8 to Example 10, Example 11 and Example 12 are different only in the addition amount of lithium difluorophosphate in the nonaqueous electrolyte solution.

TABLE 1

| | | | | Nonaqueous |
|---|---|---|---|---|
| | Negative electrode active material layer | | | electrolytic |
| | Negative | | | solution |
| | electrode | Negative | C_{dl} | LiPO₂F₂ |
| | active material | electrode sheet | (mF/cm²) | (mol/L) |
| Example 1 | Graphite A | A | 0.239 | — |
| Example 2 | Graphite A | A | 0.239 | 0.03 |
| Example 3 | Graphite A | A | 0.239 | 0.06 |
| Example 4 | Graphite A | A | 0.239 | 0.08 |
| Example 5 | Graphite A | A | 0.239 | 0.10 |
| Example 6 | Graphite A | A | 0.239 | 0.13 |
| Example 7 | Graphite A | A | 0.239 | 0.15 |
| Example 8 | Graphite B | B | 0.267 | — |
| Example 9 | Graphite B | B | 0.267 | 0.06 |
| Example 10 | Graphite B | B | 0.267 | 0.08 |
| Example 11 | Graphite C | C | 0.411 | 0.06 |
| Example 12 | Graphite C | C | 0.411 | 0.08 |

<Charging/discharging>

Six hours after the injection of the nonaqueous electrolytic solution, following the procedure shown below, each of the batteries formed relating to Example 1 to Example 12 was charged/discharged to form a coat derived from the fluorine-containing phosphate compound on a surface of the negative electrode active material. The charging/discharging was repeated 5 cycles with the (1) to (4) below as one cycle under a temperature environment of 25° C. That is, (1) constant current charge (CC charge) at a rate of 1 C up to 4.1 V, (2) 10 minutes rest, (3) constant current discharge (CC discharge) at a rate of 1 C up to 3.0 V, and (4) 10 minutes rest.

### [Measurement of Reaction Resistance]

The batteries relating to Example 1 to Example 12 after the charging/discharging were adjusted to a state of charge of SOC 60%. Under a temperature environment of 25° C., an AC impedance measurement was performed, and a diameter of an arc part of the resulted Cole-Cole plot was calculated as a reaction resistance (R_{cl}). Results are shown in columns of “reaction resistance” of Table 2.

### [Measurement of Thermal Stability]

Subsequently, the batteries relating to Example 1 to Example 12 were, after discharging to 3 V, disassembled, and the negative electrodes were taken out. Then, from the negative electrodes, using a resinous spatula, the negative electrode active material layers were scraped, and the negative electrode active materials with the coat were obtained as measurement samples. Differential scanning calorimetry (DSC) was applied on the measurement samples. Specifically, using a DSC measurement device (type “DSC-60”, manufactured by Shimadzu Corporation), a DSC measurement was performed under a nitrogen atmosphere, at a rate of temperature increase of 5° C./minute from 25° C. to 350° C. An area from 50° C. to 350° C. of the resulted DSC curve was taken as an amount of heat generation (J/g). Results are shown in a column of “amount of heat generation” in Table 2.

### [Measurement of Coat Containing Phosphorus Atoms]

An optional point of the taken out negative electrode was punched out using a punch, and a measurement sample having an area of the negative electrode amorphous layer of 1 cm² was obtained. After this was lightly cleansed two or three times with the nonaqueous solvent (mixed solvent containing EC, DMC, and EMC at a volume ratio of EC:DMC:EMC=1:1:1) used as the nonaqueous electrolytic solution, the coat components were extracted with a water-acetonitrile solution. Thereafter, such a solution was measured by ion exchange chromatography, and a concentration (μmol/cm²) of phosphorus (P) atoms per unit area was measured. Results are shown in a column of “Mₚ” of Table 2. Further, a ratio of an amount of phosphorus atoms per unit area of the negative electrode active material layer Mₚ with respect to a capacitance per unit area of the negative electrode active material layer C_{dl} is shown in a column of “Mₚ/C_{dl} ratio” of Table 2.

TABLE 2

| | Negative electrode | | | | |
|---|---|---|---|---|---|
| | active material layer | | | Evaluation result | |
| | | Mₚ | Mₚ/C_{dl} | Amount of | Reaction |
| | C_{dl} | (μmol/ | (μmol/ | heat generation | resistance |
| | (mF/cm²) | cm²) | mF) | (J/g) | (mΩ) |
| Example 1 | 0.239 | 0.026 | 0.11 | 386 | 150 |
| Example 2 | 0.239 | 0.079 | 0.33 | 420 | 145 |
| Example 3 | 0.239 | 0.182 | 0.76 | 253 | 140 |
| Example 4 | 0.239 | 0.203 | 0.85 | 135 | 140 |
| Example 5 | 0.239 | 0.222 | 0.93 | 122 | 139 |
| Example 6 | 0.239 | 0.289 | 1.21 | 111 | 144 |
| Example 7 | 0.239 | 0.332 | 1.39 | 100 | 152 |
| Example 8 | 0.267 | 0.019 | 0.07 | 435 | 134 |
| Example 9 | 0.267 | 0.187 | 0.70 | 283 | 124 |
| Example 10 | 0.267 | 0.211 | 0.79 | 150 | 125 |
| Example 11 | 0.411 | 0.160 | 0.39 | 400 | 80 |
| Example 12 | 0.411 | 0.230 | 0.56 | 420 | 84 |

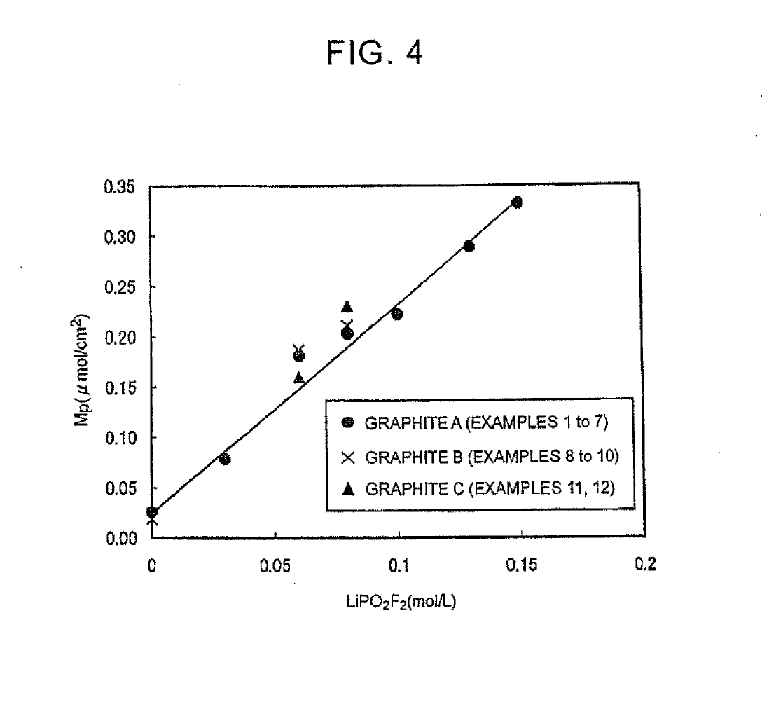

As shown in Table 2 and FIG. 4, a rough correlationship was found between the addition amount of lithium difluorophosphate (mol/L) and the amount of phosphorus atoms Mₚ (μmol/cm²). There was a tendency that the larger the addition amount of lithium difluorophosphate is, the larger the amount of phosphorus atoms (in other words, an amount of a coat containing phosphorus atoms) is. Accordingly, it was found that when some batteries different only in the addition amount of the fluorine-containing phosphate compound are prepared, and a simple preliminary test is conducted in advance, the addition amount of fluorine-containing phosphate compound properly satisfying the Mₚ/C_{dl} ratio shown here can be estimated.

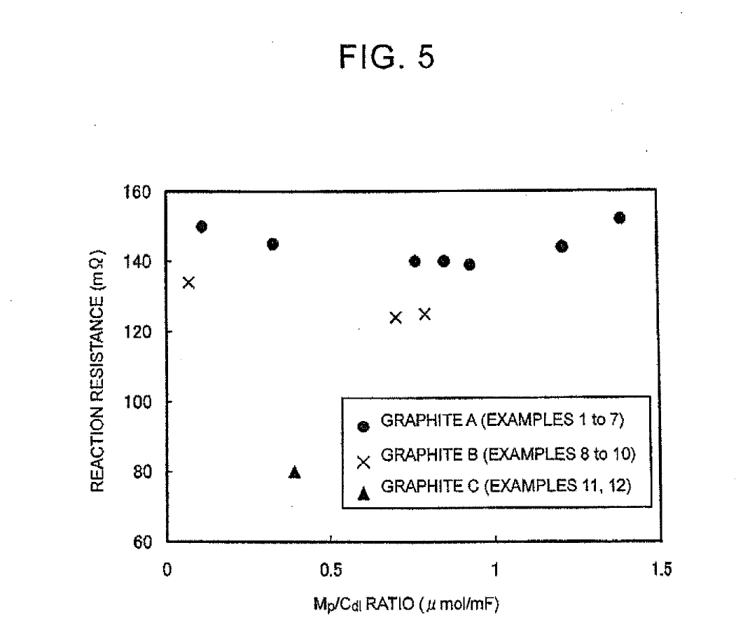

In FIG. 5, a relationship between the Mₚ/C_{dl} ratio and the reaction resistance (mΩ) is shown. As shown in Table 2 and FIG. 5, when paying attention on Examples 1 to 7 that used graphite A as the negative electrode active material, from the range where the Mₚ/C_{dl} ratio exceeds 1, the reaction resistance began increasing. As the reason for this, it is considered that because an excessive coat was formed on a surface of the negative electrode active material, the conductivity of the negative electrode active material layer was degraded. From this, it was shown that the battery satisfying Mₚ/C_{dl}≦1.21 is excellent in the conductivity and can provide high input/output characteristics.

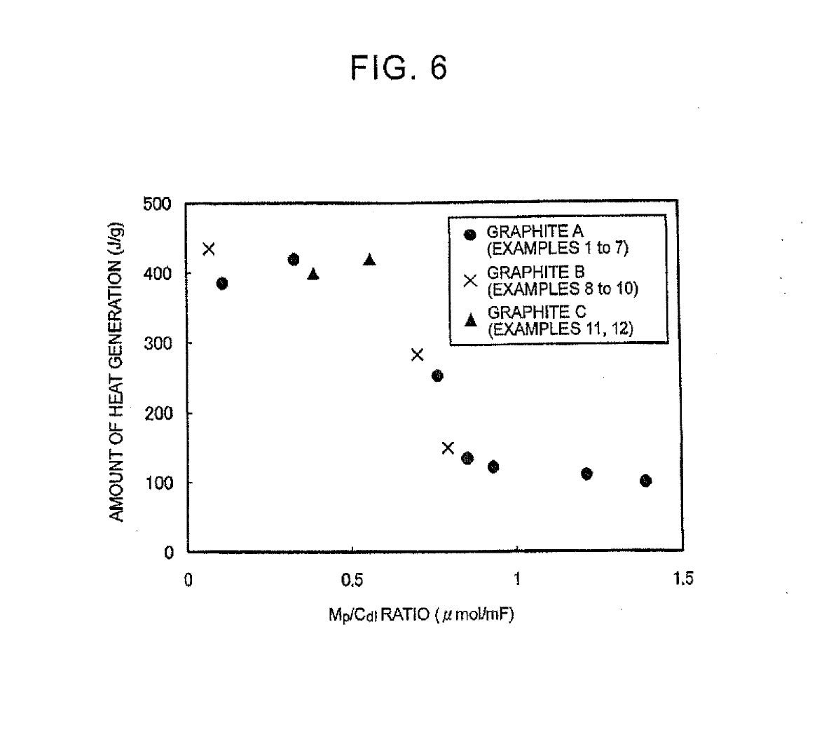

In FIG. 6, a relationship between the Mₚ/C_{dl} ratio and the amount of heat generation (J/g) is shown. As shown in Table 2 and FIG. 6, it was found that the larger the Mₚ/C_{dl} ratio is, the smaller the amount of heat generation is, that is, the coat is excellent in the thermal stability. In particular, when Mₚ/C_{dl}≧0.79 is satisfied, it was found that the amount of heat generation becomes smaller than 200 J/g or less (preferably 150 J/g or less), and the stability under high temperature environment is particularly excellent. The conceivable reason for this is because when a preferred amount of coat was formed on a surface of the negative electrode active material, an interface between the negative electrode active material and the nonaqueous electrolytic solution was stabilized. From this, it was shown that a battery provided with the coat satisfying Mₚ/C_{dl}≧0.79 can have high endurance (for example, high temperature storage characteristics and high temperature charge/discharge cycle characteristics) even under high temperature environment, for example. Thus, when the Mₚ/C_{dl} ratio is in the range of 0.79 to 1.21, a nonaqueous electrolytic solution secondary battery that can combine the endurance (in particular, high temperature endurance) and the input/output characteristics at a high level can be realized. Such results show technical significance of the invention.

In the above, specific examples of the invention have been described in detail. However, these are only exemplification, and the invention is not limited thereto. Technologies described in claims include various modifications and alterations of the specific examples exemplified in the above.

### INDUSTRIAL APPLICABILITY

The nonaqueous electrolytic solution secondary battery disclosed here can provide a battery performance (for example, endurance and input/output characteristics) higher than that of general batteries because the coat on a surface of the negative electrode active material is adequately controlled. Therefore, the battery can be preferably used in applications where high endurance and input/output characteristics are required. Examples of such applications include power sources (driving power sources) for motors mounted on vehicles such as a plug-in hybrid vehicle (PHV), a hybrid vehicle (HV), an electric vehicle (EV), an electric truck, a motorized bicycle, an electric assist bicycle, an electric wheelchair, and an electric train. Therefore, a vehicle (typically, automobile) provided with such batteries (it can have a form of a battery pack where a plurality of the batteries is connected in series) as a power source can be provided.

What is claimed is:

1. A nonaqueous electrolytic solution secondary battery comprising:
a positive electrode;
a negative electrode provided with a negative electrode active material layer containing at least a negative electrode active material;
a nonaqueous electrolytic solution; and
a coat containing phosphorus (P) atoms formed on a surface of the negative electrode active material,
wherein a ratio of an amount of phosphorus atoms per unit area of the negative electrode active material layer Mₚ with respect to a capacitance per unit area of the negative electrode active material layer C_{dl} (Mₚ/C_{dl} ratio) is 0.79 μmol/mF≦Mₚ/C_{dl}≦1.21 μmol/mF.

2. The nonaqueous electrolytic solution secondary battery according to claim 1, wherein the coat containing phosphorus atoms is formed of a compound derived from lithium difluorophosphate contained in the nonaqueous electrolytic solution as a phosphorus-containing coat forming agent.

3. The nonaqueous electrolytic solution secondary battery according to claim 1, wherein the negative electrode active material contains at least graphite particles.

4. The nonaqueous electrolytic solution secondary battery according to claim 3, wherein
an average particle size based on a laser diffraction/scattering method of the graphite particles is 0.5 μm or more and 30 μm or less; and
a specific surface area based on a BET method of the graphite particles is 0.5 m²/g or more and 20 m²/g or less.

5. A method of manufacturing a nonaqueous electrolytic solution secondary battery that includes an electrode body provided with a positive electrode having a positive electrode active material and a negative electrode having a negative electrode active material, a battery case, and a nonaqueous electrolytic solution in which a fluorine-containing phosphate compound as a phosphorus-containing coat forming agent is added, comprising the steps of:
housing the electrode body in the battery case;
injecting the nonaqueous electrolytic solution in the battery case;
performing a charging between the positive electrode and the negative electrode to form a coat containing phosphorus (P) atoms derived from the fluorine-containing phosphate compound on a surface of the negative electrode active material; and
determining an addition amount of the fluorine-containing phosphate compound so that a ratio of an amount of phosphorus atoms per unit area of the negative electrode active material layer Mₚ with respect to a capacitance per unit area of the negative electrode active material layer C_{dl} (Mₚ/C_{dl} ratio) is within a range of 0.79 μmol/mF≦Mₚ/C_{dl}≦1.21 μmol/mF.

6. The method of manufacturing according to claim 5, wherein lithium difluorophosphate is used as the fluorine-containing phosphate compound.

7. The method of manufacturing according to claim 5, wherein a concentration of the fluorine-containing phosphate compound in the nonaqueous electrolytic solution is set to 0.08 mol/L or more and 0.13 mol/L or less.

8. The method of manufacturing according to claim 5, wherein as the negative electrode active material, at least graphite particles are used.

9. The method of manufacturing according to claim 8, wherein the graphite particles that have an average particle size based on a laser diffraction/scattering method of 0.5 μm or more and 30 μm or less, and a specific surface area based on the BET method of 0.5 m²/g or more and 20 m²/g or less are used.
